(19) United States
(12) Patent Application Publication
(10) Pub. No.: US 2023/0417275 A1
(43) Pub. Date: Dec. 28, 2023

(54) PLAIN BEARING

(71) Applicant: AKTIEBOLAGET SKF, GOTEBORG (SE)

(72) Inventors: Stefan Keller, Schweinfurt (DE); Martin BUETTNER, Schwarzach (DE); Josef Hahn, Schweinfurt (DE); Philipp METZ, Katzenbach (DE)

(21) Appl. No.: 18/324,650

(22) Filed: May 26, 2023

(30) Foreign Application Priority Data
Jun. 28, 2022 (DE) 102022206539.5

(51) Int. Cl. F16C 17/02

(52) U.S. Cl. CPC F16C 17/022

(57) ABSTRACT

A plain bearing includes an outer sliding-surface element and an inner sliding-surface element enclosed by the outer sliding-surface element. The outer sliding-surface element is divided along a substantially flat surface that includes the main axis of the sliding bearing and has, at least at one axial end, a radially encircling groove. A ring configured to fixedly hold together the divided outer sliding-surface element is inserted in the groove.

### CROSS-REFERENCE

This application claims priority to German patent application no. 102022206539.5 filed on Jun. 28, 2022, the entire contents of which are incorporated.

### BACKGROUND OF THE INVENTION

The present invention relates to bearings, and more particularly to plain bearings.

Plain bearings are known and generally include an inner sliding-surface element disposed within an outer sliding-surface element. Often, the outer sliding-surface element is divided along an essentially flat surface that includes the main axis of the plain bearing, for example, produced by a breaking or a forced rupture. Typically, at least one radially encircling groove is provided on the outer surface and a metal snap ring is inserted in the groove to hold the divided outer sliding-surface element together.

However, such a metal snap ring may not ensure secure cohesion or retention of the two halves of the outer sliding-surface element in certain applications, such that subsequent installation of the plain bearing is made significantly more difficult. Furthermore, when removal forces are applied to the inner sliding-surface element during removal of the plain bearing, for example in applications where a removal force cannot be applied to the outer sliding-surface element due to the mounting environment, particularly with spherical sliding surfaces, the two halves of the outer sliding-surface element can be forced apart in a wedge-like manner, thus jamming the outer sliding-surface element in its mounting environment and impeding or preventing the removal of the plain bearing.

### SUMMARY OF THE INVENTION

An object of the present invention is to provide an improved plain bearing that avoids the problems described above. This object is achieved by a plain bearing comprising an outer sliding-surface element having two end sides and at least one radially encircling groove at one of the end sides, the outer sliding-surface element being divided along a substantially flat surface that includes a main axis of the plain bearing. An inner sliding-surface element is enclosed by the outer sliding-surface element and a ring is disposed within the at least one groove of the outer sliding-surface element and is configured to fixedly hold together the divided outer sliding-surface element.

According to the present invention, at least at the axial end of the plain bearing that lies on the side which a removal force engaging with the inner sliding-surface element is transmitted to the outer sliding-surface element, instead of a metal snap ring, a solid or enclosed ring holding the halves tightly together is used, for example, a gauge ring, that is inserted in an end-side groove or a shoulder at the transition region of the end side toward the outer surface of the outer sliding-surface element. This arrangement sufficiently secures the two halves of the outer sliding-surface element so as to prevent the above-mentioned separation of the halves and thereby ensures a problem free removal of the plain bearing. The present solution ensures a significantly improved cohesion or retention of the two halves of the outer sliding-surface element so that installation problems are also prevented.

### BRIEF DESCRIPTION OF THE SEVERAL VIEWS OF THE DRAWING

Further advantages, features, and details of the invention arise from the following exemplary embodiment of the invention described based on the drawing FIGURE. In other embodiments modifications arise, of course of this one exemplary embodiment, inter alia in the context of what is outlined in the patent claims:

FIG. 1 is broken-away, axial cross-sectional view of a plain bearing, showing only a right half thereof.

### DETAILED DESCRIPTION OF THE INVENTION

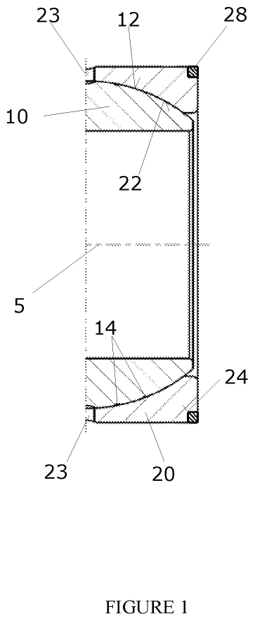

As discussed above, FIG. 1 shows the right half of a plain bearing as cut along a main axis 5 of the bearing. The plain bearing includes a one-piece, annular, inner sliding-surface element 10 with an outer surface providing a sliding surface 12. The sliding surface 12 is configured or formed to correspond with a curved surface of a spherical disc and includes a lubrication groove 14, for example, formed in a square-grid-type configuration. In other embodiments, the sliding surface 12 may be formed differently, in particular with any other appropriate type of lubrication groove system. The inner sliding-surface element 10 is preferably formed from a rolling-element bearing steel, most preferably a bearing steel hardened to at least 50 HRC and/or phosphated. In other embodiments, the inner sliding-surface element 10 may be chromated or a steel-steel sliding-surface plating may alternatively be used. Furthermore, during transport or delivery of the plain bearing, the sliding surface 12 can be treated with a running-in lubricant or merely protected by a corrosion inhibitor.

The inner sliding-surface element 10 is enclosed by an outer sliding-surface element 20. The outer sliding-surface element 20 has an inner sliding surface 22 adapted to the inner sliding-surface element 10. Specifically, the sliding surface 22 also corresponds to the curved surface of a spherical disc and is configured to slidingly mate with the sliding surface 12 of the inner sliding-surface element 10. In other words, the two sliding surfaces 12, 22 are mutually adapted. Preferably, the outer sliding-surface element 20 is also formed from a rolling-element bearing steel, most preferably hardened to at least 50 HRC and phosphated. The sliding surface 22 is also preferably treated during transport/delivery with a running-in lubricant. The alternative embodiments described above for the inner sliding-surface element 10 correspondingly apply to the outer sliding-surface element 20. Furthermore, the outer sliding-surface element 20 preferably further includes two lubrication bores 23 radially penetrating the outer sliding-surface element 20.

The outer sliding-surface element 20 is preferably formed divided, for example, by a breaking or cutting of an initially one-piece ring, or a forced rupture, along an essentially flat surface that includes a main axis 5 of the plain bearing. The dividing of the outer sliding-surface element 20 enables the inner sliding-surface element 10 to be assembled within the outer element 20. However, due to such a divided or two-piece structure, the two halves of the outer sliding-surface element 20 must be held together during use.

For this purpose, at least one radially encircling open-ended groove or shoulder 24 is provided, preferably at least at the right axial end of the outer sliding-surface element 20 as shown, within which a closed or solid fitted ring 28 is disposed. The fitted ring 28 is configured to fixedly hold or retain together the two halves of the outer sliding-surface element 20. Preferably, the ring 28 is formed as a fitted, solid ring or as a “closed” ring and is preferably formed of a metallic material, most preferably steel.

The fitted ring 28 may be installed about the shoulder or groove 24 by pushing or displacing the ring 28 axially toward the outer sliding-surface element 20 such that the solid fitted ring 28 enters the open end of the groove/shoulder 24 and slides onto and about the annular shoulder 24. Alternatively, the ring 28 may be initially open and “wrapped around” the groove or shoulder 24 and then enclosed by connecting two circumferential ends (not depicted) to form a solid, fitted ring 28. In either case, such a closed, fitted ring 28 is formed of a rigid material (e.g., a metal or rigid polymer) and prevents any relative movement between the halves of the outer sliding-surface element 20, unlike a snap ring or an elastic ring which each are radially expandable or deflectable and thereby allows relative movement of the two portions of the divided element 20.

Preferably, the shoulder or groove 24 is sized relative to the outer sliding-surface element 20 such that when the outer sliding-surface element 20 has an outer diameter of, for example, one hundred twenty-five millimeters (125 mm), the shoulder 24 is formed with an approximately square cross-section of three millimeters by three millimeters (3 mm×3 mm). Further, the shoulder or “open” groove 24 has generally rounded corners and/or edge regions. The fitted ring 28 is disposed within or about the shoulder/groove 24 and preferably has approximately square cross sections and is sized so the ring 28 does not protrude beyond the outer surface or the axial end side of the outer sliding-surface element 20.

On the left axial end of FIG. 1 (not shown), the plain bearing is preferably configured substantially similarly to the right axial end as shown and described above, such that there is preferably no order of installation required, i.e., a ring 28 may first be installed within the shoulder/groove 24 on the left end side prior to installing a ring 28 at the right end side or vice-versa. However, in other embodiments, the other or left axial end may instead be configured with a groove on the outer surface of the outer sliding-surface element 20, in which, for example a snap ring known from the prior art or a rubber-elastic ring may be inserted, such as disclosed in German Patent Application No. 102022204310.3 which is incorporated fully herein by reference.

In other embodiments, the “holding-together” or “retention” ring 28 may be formed from or comprise any other appropriate materials. Further, the cross-sectional area of the fitted ring 28 and the shoulder 24 may have any other shape other than square-like, for example, the cross-sectional area may be rectangular in shape. Also, in other embodiments, a groove 24 may be incorporated in the end side of the outer sliding-surface element 20 may be provided instead of the shoulder 24. Furthermore, the width and height of the shoulder or groove 24, as well as the associated ring 28, preferably has a value that generally corresponds to approximately one percent (1%) to five percent (5%) of the value of the outer diameter of the outer sliding-surface element 20.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### REFERENCE NUMBER LIST

5 Main axis
10 Inner sliding-surface element
12 Sliding surface
14 Lubrication groove
20 Outer sliding-surface element
22 Sliding surface
23 Lubrication bore
24 Shoulder
28 Gauge ring

We claim:

1. A plain bearing comprising:
an outer sliding-surface element having two end sides and at least one radially encircling groove at one of the end sides, the outer sliding-surface element being divided along a substantially flat surface that includes a main axis of the plain bearing;
an inner sliding-surface element enclosed by the outer sliding-surface element; and
a ring disposed within the at least one groove of the outer sliding-surface element and configured to fixedly hold together the divided outer sliding-surface element.

2. The plain bearing according to claim 1, wherein at least one:
the outer sliding-surface element has an inner sliding surface, the inner sliding-surface element has an outer sliding surface, the inner sliding surface and the outer sliding surface being mutually adapted and correspond approximately to the curved region of the surface of a spherical disc;
the outer sliding-surface element and the inner sliding-surface element are each configured annular; and
the inner sliding-surface element is formed one-piece.

3. The plain bearing according to claim 1, wherein at least one of:
the ring is formed as a fitted, continuous ring or as a ring with connected ends; and
the ring is formed from of a metallic material or a polymeric material.

4. The plain bearing according to claim 1, wherein the outer sliding-surface element has an outer surface and a groove is provided by a shoulder at the transition region from the outer surface of the outer sliding-surface element to the one end side of the outer sliding-surface element.

5. The plain bearing according to claim 1, wherein a width and/or depth of the groove, or of the shoulder and/or of the ring, correspond to approximately 1% to 5% of the outer diameter of the outer sliding-surface element.

6. The plain bearing according to claim 1, wherein the cross-sectional surface of at least one of the groove, the shoulder and the ring are configured adapted to each other, in particular rectangular or square-like.

7. The plain bearing according to claim 1, wherein the outer sliding-surface element has an outer surface and the ring is sized such that the ring does not protrude outwardly from the outer surface of the outer sliding-surface element or from the end side of the outer sliding-surface element.

8. The plain bearing according to claim 1, wherein one of:
the outer sliding-surface element has two grooves or shoulders, each one of the grooves or shoulders being located at a separate one of two axial ends of the outer sliding-surface element, and a fitted ring is disposed within each one of the two grooves or shoulders; and
a fitted ring is disposed within a groove or shoulder at one axial end of the outer sliding-surface element and a rubber-elastic ring is inserted into a groove formed in the outer surface of the outer sliding-surface element adjacent to the other axial end of the outer sliding-surface element.

9. A plain bearing comprising:
an outer sliding-surface element having two axial end sides and an annular shoulder formed adjacent to one of the two axial end sides, the outer sliding-surface element being divided along a substantially flat surface that includes a main axis of the plain bearing;
an inner sliding-surface element enclosed by the outer sliding-surface element; and
a rigid ring disposed about the annular shoulder of the outer sliding-surface element and configured to fixedly hold together the divided outer sliding-surface element.
